(19) United States
(12) Patent Application Publication
(10) Pub. No.: US 2025/0326288 A1
(43) Pub. Date: Oct. 23, 2025

(54) MULTIPLE BRANCH COOLANT SYSTEM

(71) Applicant: GM GLOBAL TECHNOLOGY OPERATIONS LLC, Detroit, MI (US)

(72) Inventors: Justin A. Bunnell, Farmington Hills, MI (US); Philip J. Prociw, Clinton Township, MI (US); Andres V. Mituta, Lake Orion, MI (US); Benjamin C. Groen, Troy, MI (US)

(73) Assignee: GM GLOBAL TECHNOLOGY OPERATIONS LLC, Detroit, MI (US)

(21) Appl. No.: 18/640,042

(22) Filed: Apr. 19, 2024

(51) Int. Cl. B60K 11/02; H01M 10/613; H01M 10/6568

(52) U.S. Cl. CPC B60K 11/02; H01M 10/613; H01M 10/6568; H01M 2250/20

(57) ABSTRACT

A cooling system for a multi-cell rechargeable energy storage system (RESS) having a plurality of battery cells arranged in individual battery modules includes a main coolant loop configured to circulate a coolant. The cooling system additionally includes a plurality of coolant branches arranged in parallel. Each coolant branch is configured to receive a portion of the coolant from the main coolant loop to remove thermal energy from one of the respective battery modules. The cooling system further includes at least one flow-valve configured to regulate and distribute across the plurality of coolant branches the coolant circulated through the main coolant loop. One-way valves may be used to control the flow of coolant out of respective coolant branches. A motor vehicle employing such a RESS and the cooling system is also included.

### INTRODUCTION

The present disclosure relates to a multiple branch coolant system for a multi-cell rechargeable energy storage system (RESS).

Typically, an electric energy generation and storage battery system includes one or more battery cells for powering a load. A plurality of battery cells may be arranged in close proximity to one another to generate a battery module and a plurality of battery modules may be organized into a battery pack array. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Exposure of a battery cell to elevated temperatures over prolonged periods may cause the cell to experience a thermal runaway event, where heat build-up in an individual cell leads to the heat spreading to adjacent cells in the module and affecting the entire battery array. Accordingly, thermal energy needs to be effectively removed to mitigate heat build-up and consequent degradation of battery system performance. Generally, devices such as heat-sinks or cold-plates with circulating coolant are employed to remove heat from battery systems.

### SUMMARY

A multi-cell rechargeable energy storage system (RESS) includes a plurality of battery cells arranged in individual battery modules. The RESS also includes a cooling system having a main coolant loop configured to circulate a coolant. The RESS additionally includes a plurality of coolant branches arranged fluidly in parallel. Each coolant branch is configured to receive a portion of the coolant from the main coolant loop to remove thermal energy from one of the respective battery modules. Additional parallel cooling branches may be used for circulating coolant through other internal battery components that require liquid cooling, such as a Battery Disconnect Unit (BDU), electrical connectors, and a DC/DC converter for supplying 12V/48V power to the vehicle. The RESS further includes at least one flow-valve configured to regulate and distribute across the plurality of coolant branches the coolant circulated through the main coolant loop.

The flow-valve may be a multi-way valve assembly arranged in a junction between the main coolant loop and the plurality of coolant branches. Such a multi-way valve may be configured to control the flow of the coolant into each of the coolant branches.

Alternatively, a plurality of throttle valves may regulate the flow of the coolant from the main coolant loop. Each throttle valve may be arranged in one of the coolant branches upstream of the corresponding battery module and be configured to control the flow of the coolant into the subject coolant branch.

Each coolant branch may include a one-way valve configured to control the flow of the coolant out of the subject coolant branch.

The cooling system may also include a fluid pump configured to circulate the coolant through the main coolant loop.

The cooling system may additionally include a coolant chiller configured to remove thermal energy from the coolant in the main coolant loop.

The cooling system may also include a coolant heater configured to add thermal energy to the coolant in the main coolant loop.

The multi-cell RESS may further include an electronic controller configured to regulate operation of the flow-valve(s), the fluid pump, the coolant chiller, and the coolant heater.

The electronic controller may be configured to regulate temperature of the individual battery modules via the fluid pump, the coolant chiller, and/or the coolant heater. The electronic controller may also regulate temperature of other components or subsystems such as the BDU, electrical connectors, and the DC/DC converter.

The electronic controller may be additionally configured to regulate temperature of the individual battery modules by apportioning the flow of the coolant between the plurality of coolant branches via the flow-valve(s).

A motor vehicle employing a multi-cell rechargeable energy storage system (RESS) with the cooling system, as described above, is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a multi-cell rechargeable energy storage system (RESS) configured to generate and store electrical energy used by vehicle systems including the power-sources, according to the disclosure.

FIG. 2 is a schematic illustration of the RESS shown in FIG. 1, including an embodiment of a coolant system having a main coolant loop and multiple parallel coolant branches subsystem for removing thermal energy from individual battery modules, according to the disclosure.

FIG. 3 is a schematic illustration of the RESS shown in FIG. 1, including another embodiment of a coolant system having a main coolant loop and multiple parallel coolant branches subsystem for removing thermal energy from individual battery modules, according to the disclosure.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

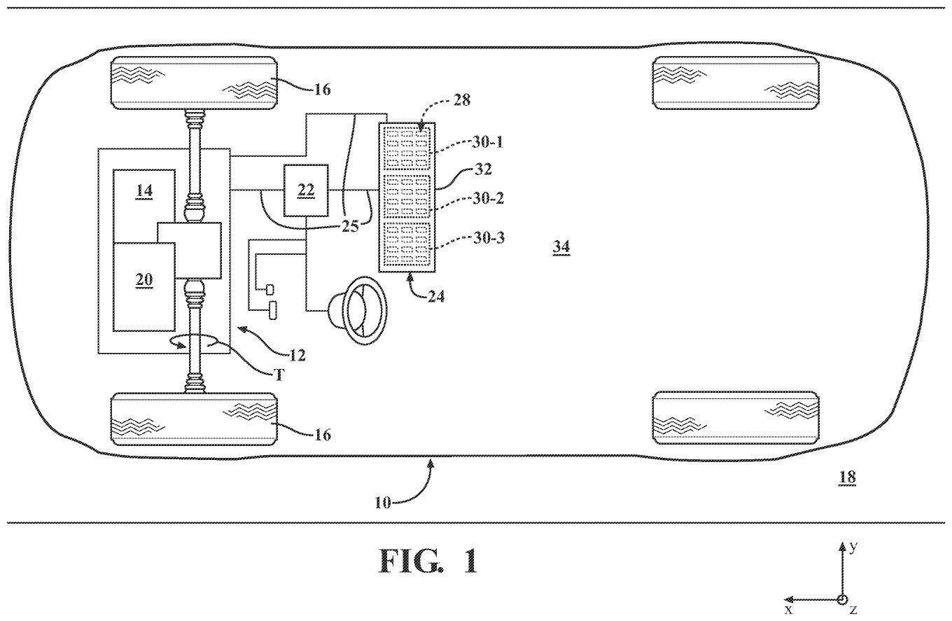

Referring to the drawings, wherein like reference numbers refer to like components, FIG. 1 shows a schematic view of a motor vehicle 10 having a powertrain 12. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may include an additional power-source 20, such as an internal combustion engine. The power-sources 14 and 20 may act in concert to power the vehicle 10. The vehicle 10 additionally includes a central processing unit (CPU) 22 and a multi-cell rechargeable energy storage system (RESS) 24 configured to generate and store electrical energy through heat-producing electro-chemical reactions for supplying the electrical energy to the power-sources 14 and 20. The CPU 22 regulates various systems of the vehicle 10, including the powertrain 12 to generate a predetermined amount of power-source torque T. The RESS 24 may be connected to the power-sources 14 and 20, to the CPU 22, as well as to other vehicle systems via a high-voltage BUS 25.

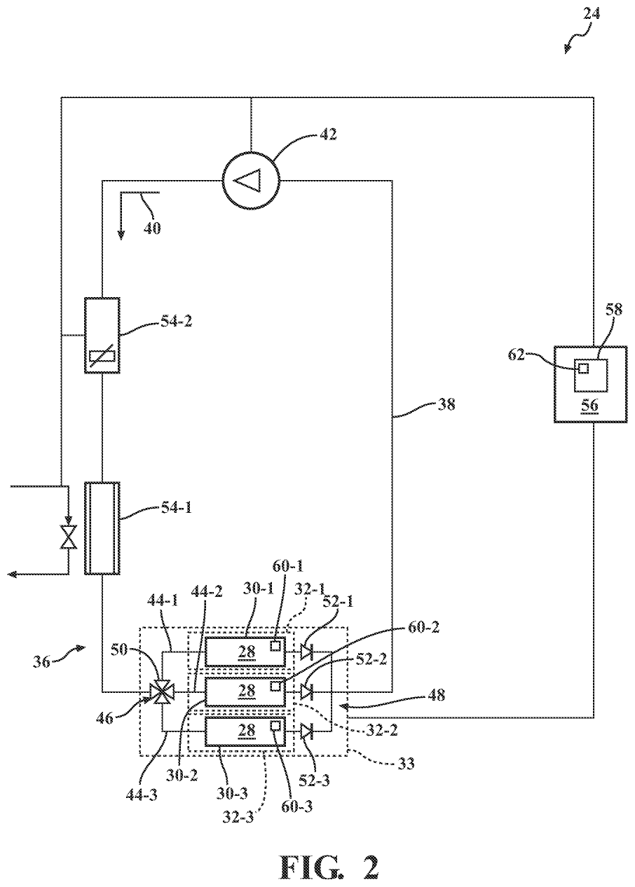

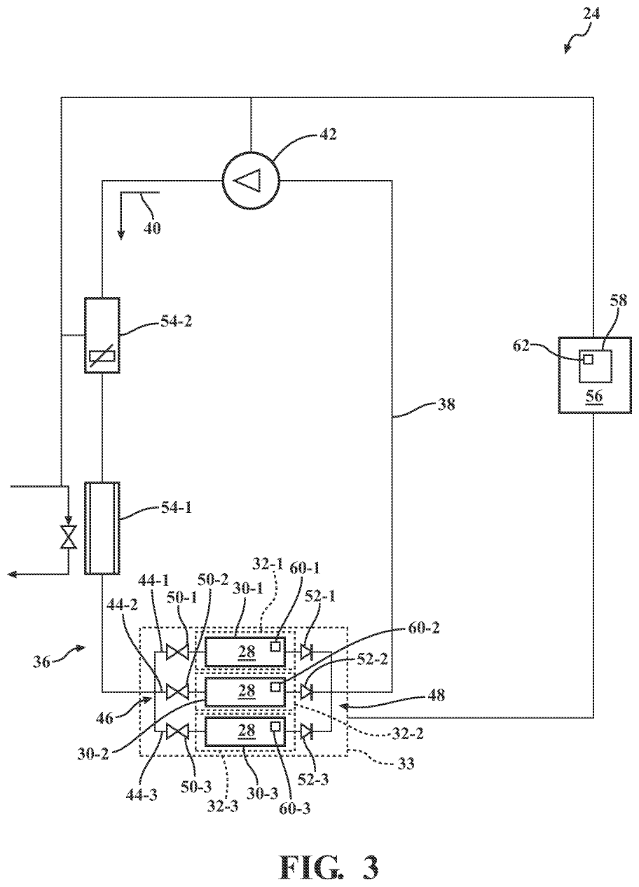

As shown in FIGS. 1-3, the RESS 24 includes a plurality of battery cells 28 arranged in individual battery groups or modules, such as a first module 30-1, a second module 30-2, and a third module 30-3. The subject modules 30-1, 30-2, 30-3 may be arranged electrically in series or in parallel. Although three individual battery modules are specifically shown, it is intended that the RESS 24 includes at least two respective modules, and multiple modules may be organized into battery packs or subpacks. The remainder of the present description will focus on RESS 24 construction having three battery modules 30-1, 30-2, 30-3, with each battery module having a desired quantity of battery cells 28. As shown in FIGS. 2 and 3, each battery module 30-1, 30-2, 30-3 may include a respective battery module enclosure 32-1, 32-2, 32-3 configured to house and support the corresponding battery cells 28. The RESS 24 may also include a battery pack enclosure 33 surrounded by an ambient environment 34. The battery pack enclosure 33 is configured to house and support the battery modules 30-1, 30-2, 30-3.

As shown in FIGS. 2 and 3, RESS 24 also includes a cooling system 36 configured to remove thermal energy from various temperature sensitive components of the RESS. Cooling system 36 includes a main coolant loop 38 configured to circulate a coolant 40 through the RESS 24. As shown, cooling system 36 further includes a fluid pump 42 configured to circulate coolant 40 through the main coolant loop 38. The cooling system 36 also includes a plurality of coolant branches, shown as a first branch 44-1, a second branch 44-2, and a third branch 44-3, in fluid communication with the main coolant loop 38. Each of the coolant branches 44-1, 44-2, 44-3 extends through a respective battery module 30-1, 30-2, 30-3, proximate and along the constituent battery cells 28.

Furthermore, each coolant branch 44-1, 44-2, 44-3 is configured to receive a portion of the coolant 40 from the main coolant loop 38. The coolant branches 44-1, 44-2, 44-3 are arranged fluidly in parallel to receive respective portions of the coolant 40. The coolant branches 44-1, 44-2, 44-3 are thereby configured to independently circulate their respective portions of the coolant 40 and remove thermal energy from the corresponding battery modules 30-1, 30-2, 30-3. As shown, the main coolant loop 38 may be in fluid communication with additional parallel coolant branches, for example to circulate the coolant through auxiliary power modules (APMs), a Battery Disconnect Unit (BDU) including various electrical switches and relays, electrical connectors, a DC/DC converter for supplying 12V/48V power to the vehicle, etc., each having a particular temperature requirement.

With continued reference to FIGS. 2 and 3, the RESS 24 may also include an inlet manifold 46 configured to connect the main coolant loop 38 to the coolant branches 44-1, 44-2, 44-3 and an outlet manifold 48 configured to connect the coolant branches back to the main coolant loop. Accordingly, the inlet and outlet manifolds 46, 48 are together configured to maintain circulation of coolant 40 through the cooling system 36. The cooling system 36 additionally includes at least one flow-valve 50. The flow-valve(s) 50 are configured to regulate and distribute across the individual coolant branches 44-1, 44-2, 44-3, the coolant 40 circulated through and received from the main coolant loop 38. In other words, the flow-valve(s) 50 are specifically structured and operated to provide independent regulation of coolant flow into each individual coolant branch 44-1, 44-2, 44-3.

As shown in FIG. 2, the flow-valve 50 may be a multi-way valve assembly arranged in a junction, such as the inlet manifold 46, between the main coolant loop 38 and the plurality of coolant branches 44-1, 44-2, 44-3 upstream of each battery module 30-1, 30-2, 30-3. The multi-way valve assembly embodiment of the flow-valve 50 may be configured to control the flow of coolant 40 into each of the coolant branches 44-1, 44-2, 44-3. As shown in FIG. 3, the flow-valve(s) 50 may be a plurality of individual throttle valves 50-1, 50-2, 50-3. Each subject throttle valve 50-1, 50-2, 50-3 may be arranged in one of the plurality of coolant branches 44-1, 44-2, 44-3 upstream of the corresponding battery module 30-1, 30-2, 30-3 and configured to control the flow of the coolant 40 into the subject coolant branch.

As shown in FIGS. 2 and 3, each coolant branch 44-1, 44-2, 44-3 may include a respective one-way valve 52-1, 52-2, 52-3. The one-way valves 52-1, 52-2, 52-3 are configured to prevent backflow of the coolant 40 into the corresponding coolant branches 44-1, 44-2, 44-3. Each of the one-way valves 52-1, 52-2, 52-3 is arranged aft of the flow-valve(s) 50 and downstream of the corresponding battery module 30-1, 30-2, 30-3. Accordingly, each one-way valve 52-1, 52-2, 52-3 is configured to control the flow of the corresponding portion of the coolant 40 through and out of the subject coolant branch 44-1, 44-2, 44-3. Cooling system 36 may also include a plurality of heat exchangers arranged in the main coolant loop 38 to alter the temperature of the coolant 40. For example, one embodiment of such a heat exchanger may be a coolant chiller 54-1, for example, using a refrigerant, to remove thermal energy from the coolant 40 in the main coolant loop 38. Another embodiment of such a heat exchanger may be a coolant heater 54-2, for example, using electrical resistance, to add thermal energy to the coolant 40.

As shown in FIGS. 2 and 3, the multi-cell RESS 24 may additionally include an electronic controller 56 that may be either electronically connected to or be part of the CPU 22. The electronic controller 56 may be configured or programmed to regulate operation of the cooling system 36 or be structured to manage operation of the RESS 24 as a whole. As shown, the electronic controller 56 is in operative communication with the fluid pump 42, the flow-valve(s) 50, the coolant chiller 54-1, and the coolant heater 54-2. To support requisite management of the RESS 24 and/or the cooling system 36, the electronic controller 56 specifically includes a processor and tangible, non-transitory memory, which includes requisite instructions programmed therein. The controller's memory may be an appropriate recordable medium that participates in providing computer-readable data or process instructions. Such a recordable medium may take many forms, including but not limited to non-volatile media and volatile media.

Non-volatile media for electronic controller 56 may include, for example, optical or magnetic disks and other persistent memory. Volatile media may include, for example, dynamic random-access memory (DRAM), which may constitute a main memory. The instructions programmed into the controller 56 may be transmitted by one or more transmission medium, including coaxial cables, copper wire and fiber optics, including the wires that comprise a system bus coupled to a processor of a computer, or via a wireless connection. Memory of the electronic controller 56 may also include a flexible disk, hard disk, magnetic tape, another magnetic medium, a CD-ROM, DVD, another optical medium, etc. The electronic controller 56 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry.

Algorithm(s), indicated generally via numeral 58, required by the electronic controller 56 or accessible thereby may be stored in the memory of the controller and automatically executed to facilitate operation of the RESS 24 and/or the cooling system 36. Specifically, the algorithm(s) 58 may include an inventory mode configured to monitor operation of the fluid pump 42, the flow-valve(s) 50, the coolant chiller 54-1, and the coolant heater 54-2. The electronic controller 56 may be configured to regulate temperature of the individual battery modules 30-1, 30-2, 30-3 via at least one of the fluid pump 42, the coolant chiller 54-1, and the coolant heater 54-2. The electronic controller 56 may be further configured, e.g., via the algorithm(s) 58, to regulate temperature of the individual battery modules 30-1, 30-2, 30-3 by apportioning the flow of the coolant 40 between the individual coolant branches 44-1, 44-2, 44-3 via the flow-valve(s) 50.

For example, the RESS 24 may further include individual temperature sensors 60-1, 60-2, 60-3 embedded in corresponding battery modules 30-1, 30-2, 30-3 (as well as respective temperature sensors in auxiliary power modules and subsystem components, such as the BDU, electrical connectors, and the DC/DC converter discussed above) and in communication with the electronic controller 56. The electronic controller 56 may be programmed to receive temperature signals from respective sensors 60-1, 60-2, 60-3 and compare the detected temperatures with a predetermined acceptable temperature range 62 for requisite operation of the corresponding battery modules 30-1, 30-2, 30-3 (and using signals from additional dedicated sensors compare temperatures of auxiliary power modules and subsystem components). Such an acceptable temperature range 62 may be determined empirically for a variety of operating modes, such as cold-start, steady-state, or heavy load operation of the RESS 24 and the vehicle 10.

The sensors 60-1, 60-2, 60-3 may be further used to achieve closed-loop control of the cooling system 36 to stabilize temperature of the battery modules 30-1, 30-2, 30-3 (as well auxiliary power modules and subsystem components). When the temperature detected by one or more sensors 60-1, 60-2, 60-3 (or auxiliary power modules and subsystem components) shifts outside the acceptable temperature range 62, the electronic controller 56 may command the fluid pump 42 to increase or decrease the flow of coolant 40, lower or increase temperature of the coolant via the coolant chiller 54-1 or the coolant heater 54-2. Additionally, the electronic controller 56 may apportion the flow of coolant 40 between the individual coolant branches 44-1, 44-2, 44-3 by regulating the flow-valve(s) 50. As a result, the coolant flow having an increased or decreased temperature may be directed in greater or reduced volumetric flow rate to specific coolant branch or branches 44-1, 44-2, 44-3 of corresponding battery module(s) that are out of the acceptable temperature range 62.

Overall, the parallel coolant branch structure of the cooling system 36 permits controlled distribution of coolant among individual battery modules. The flow-valve(s) 50 upstream of individual battery modules specifically enable the subject control over the coolant flow. Respective one-way valves 52-1, 52-2, 52-3 situated in parallel coolant branches also contribute to the effectiveness of the cooling system in controlling coolant flow through the respective coolant branches. Control over the distribution of coolant in turn allows individual battery modules to receive separate temperature adjustment, rather than, for example, unusual conditions within a single battery module forcing coolant flow and/or temperature adjustment throughout the entire RESS.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A multi-cell rechargeable energy storage system (RESS) comprising:
a plurality of battery cells arranged in individual battery modules; and
a cooling system including:
a main coolant loop configured to circulate a coolant;
a plurality of coolant branches arranged in parallel, wherein each coolant branch is configured to receive a portion of the coolant from the main coolant loop to remove thermal energy from one of the respective battery modules; and
at least one flow-valve configured to regulate and distribute across the plurality of coolant branches the coolant circulated through the main coolant loop.

2. The multi-cell RESS of claim 1, wherein the at least one flow-valve is a multi-way valve assembly arranged in a junction between the main coolant loop and the plurality of coolant branches and configured to control a flow of the coolant into each of the coolant branches.

3. The multi-cell RESS of claim 1, wherein the at least one flow-valve is a plurality of throttle valves, each throttle valve arranged in one of the plurality of coolant branches upstream of the corresponding battery module and configured to control a flow of the coolant into the subject coolant branch.

4. The multi-cell RESS of claim 1, wherein each coolant branch includes a one-way valve configured to control a flow of the coolant out of the subject coolant branch.

5. The multi-cell RESS of claim 1, wherein the cooling system additionally includes a fluid pump configured to circulate the coolant through the main coolant loop.

6. The multi-cell RESS of claim 5, wherein the cooling system additionally includes a coolant chiller configured to remove thermal energy from the coolant in the main coolant loop.

7. The multi-cell RESS of claim 6, wherein the cooling system additionally includes a coolant heater configured to add thermal energy to the coolant in the main coolant loop.

8. The multi-cell RESS of claim 7, further comprising an electronic controller configured to regulate operation of the at least one flow-valve, the fluid pump, the coolant chiller, and the coolant heater.

9. The multi-cell RESS of claim 8, wherein the electronic controller is additionally configured to regulate temperature of the individual battery modules by apportioning the coolant between the plurality of coolant branches via the at least one flow-valve.

10. A motor vehicle comprising:
an electric motor-generator configured to generate torque;
a multi-cell rechargeable energy storage system (RESS) configured to supply electrical energy to the electric motor-generator, the RESS including:
a plurality of battery cells arranged in individual battery modules; and
a cooling system including:
a main coolant loop configured to circulate a coolant;
a plurality of coolant branches arranged in parallel, wherein each coolant branch is configured to receive a portion of the coolant from the main coolant loop to remove thermal energy from one of the respective battery modules; and
at least one flow-valve configured to regulate and distribute across the plurality of coolant branches the coolant circulated through the main coolant loop; and
an electronic controller configured to regulate operation of the at least one flow-valve.

11. The motor vehicle of claim 10, wherein the at least one flow-valve is a multi-way valve assembly arranged in a junction between the main coolant loop and the plurality of coolant branches and configured to control a flow of the coolant into each of the coolant branches.

12. The motor vehicle of claim 10, wherein the at least one flow-valve is a plurality of throttle valves, each throttle valve arranged in one of the plurality of coolant branches upstream of the corresponding battery module and configured to control a flow of the coolant into the subject coolant branch.

13. The motor vehicle of claim 10, wherein each coolant branch includes a one-way valve configured to control a flow of the coolant out of the subject coolant branch.

14. The motor vehicle of claim 10, wherein the cooling system additionally includes a fluid pump configured to circulate the coolant through the main coolant loop.

15. The motor vehicle of claim 14, wherein the cooling system additionally includes a coolant chiller configured to remove thermal energy from the coolant in the main coolant loop.

16. The motor vehicle of claim 15, wherein the cooling system additionally includes a coolant heater configured to add thermal energy to the coolant in the main coolant loop.

17. The motor vehicle of claim 16, wherein the electronic controller is configured to regulate temperature of the individual battery modules via at least one of the fluid pump, the coolant chiller, the coolant heater, and by apportioning the coolant between the plurality of coolant branches via the at least one flow-valve.

18. A cooling system for a multi-cell rechargeable energy storage system (RESS) having a plurality of battery cells arranged in individual battery modules, the cooling system comprising:
a main coolant loop configured to circulate a coolant;
a plurality of coolant branches arranged in parallel, wherein:
each coolant branch is configured to receive a portion of the coolant from the main coolant loop to remove thermal energy from one of the respective battery modules; and
each coolant branch includes a one-way valve configured to control a flow of the coolant out of the subject coolant branch;
at least one flow-valve configured to regulate and distribute across the plurality of coolant branches the coolant circulated through the main coolant loop;
a fluid pump configured to circulate the coolant through the main coolant loop;
a coolant chiller configured to remove thermal energy from the coolant in the main coolant loop;
a coolant heater configured to add thermal energy to the coolant in the main coolant loop; and
an electronic controller configured to regulate operation of at least one of the fluid pump, the coolant chiller, the coolant heater, and the at least one flow-valve.

19. The cooling system of claim 18, wherein the at least one flow-valve is a multi-way valve assembly arranged in a junction between the main coolant loop and the plurality of coolant branches and configured to control a flow of the coolant into each of the coolant branches.

20. The multi-cell RESS of claim 18, wherein the at least one flow-valve is a plurality of throttle valves, each throttle valve arranged in one of the plurality of coolant branches upstream of the corresponding battery module and configured to control a flow of the coolant into the subject coolant branch.
